(19) United States
(12) Patent Application Publication
(10) Pub. No.: US 2025/0148546 A1
(43) Pub. Date: May 8, 2025

(54) COMPUTED INEQUALIIES SOLUTION

(71) Applicants: Alexander K. JOHNSON, Davidsonville, MD (US); Warren D. Todd JOHNSON, Davidsonville, MD (US)

(72) Inventors: Alexander K. JOHNSON, Davidsonville, MD (US); Warren D. Todd JOHNSON, Davidsonville, MD (US)

(21) Appl. No.: 19/014,387

(22) Filed: Jan. 9, 2025

Related U.S. Application Data
(63) Continuation of application No. 17/883,085, filed on Aug. 8, 2022.
Application No. 17/883,085 is a continuation of application No. 16/078,766, filed on Aug. 22, 2018, now abandoned.
(60) Provisional application No. 62/299,695, filed on Feb. 25, 2016.

(51) Int. Cl. G06Q 40/12; G06Q 20/08; G06Q 20/10; G06Q 40/02

(52) U.S. Cl. CPC G06Q 40/125; G06Q 20/085; G06Q 20/102; G06Q 40/02

(57) ABSTRACT

The preceding disclosure concerns a novel computed inequality solution to income inequality and wealth inequality (the “Solution”). The Solution is comprised of, among other elements, the following embodiments: an income equality generator; a wealth equality generator: future income swaps; future wealth swaps; income verification for future income swaps; and wealth verification for future wealth swaps. The embodiments are useful, novel, and non-obvious individually. Likewise, the embodiments are useful, novel, and non-obvious when taken collectively. Income inequality and/or wealth inequality—the problem(s) solved by the income equality generator and/or wealth equality generator alone or in combination with future income swaps and/or future wealth swaps and income verification for future income swaps and/or wealth verification for future wealth swaps—do not occur in nature, are a relatively new problem, and are problems that have increased in magnitude in recent years. The Solution does not constitute a software implementation of a process that is already in use. Nor do the embodiments, either individually or collectively. Importantly, we do not seek patent protection for all means by which income equality and/or wealth equality may be generated; for all swap products (i.e., those not related to income or wealth); or other income verification processes for future income swaps and/or future wealth swaps that may be similar to those that are detailed in this application.

### CROSS-REFERENCE TO RELATED APPLICATION

This application is a divisional of application Ser. No. 17/883,085, filed Aug. 8, 2022, which is a continuation of application Ser. No. 16/078,766, filed Aug. 22, 2018, which is a national stage entry of application no. PCT/US2017/019663. filed Feb. 27, 2017, which claims priority from a provisional application No. 62/299,695, each application of which is hereby incorporated herein by reference in its entirety

### TECHNICAL FIELD

The present disclosure concerns a novel solution to income inequality and wealth inequality (the “Solution”). The Solution is comprised of, among other elements, the following embodiments: an income equality generator; a wealth equality generator; future income swaps: future wealth swaps; income verification for future income swaps; and wealth verification for future wealth swaps. The embodiments are useful, novel, and non-obvious individually. Likewise, the embodiments are useful, novel, and non-obvious when taken collectively. Provided herein are processes, products, and the like.

### INTRODUCTION

Modern societies suffer from significant income inequality and/or wealth inequality. resulting in the stratification of general wellbeing. Even in the United States, forces that drive its capitalistic economy, while providing a generalized opportunity for all persons to benefit, result in this stratification due to individual circumstances, many of which are extenuating. In addition, in a capitalistic economy, even those who do not feel personally disadvantaged will seek ways by which they can raise their expected level of income and/or wealth

Whether for social reasons or for reasons related to the desire to better oneself, we believe an opportunity exists, an opportunity with far reaching implications for society and a unique opportunity for profit. We believe individuals will make intelligent decisions concerning their future wellbeing, and will agree to a potential future sacrifice (e.g., some portion of their future income and/or future wealth that exceeds pre-established thresholds), or to invest currently (i.e., making a current payment/cash outlay or a series of payments/cash outlays; e.g., monthly, annually, or any other frequency agreed upon), or both, in order to guarantee a future payment, or an enhanced future level of income or wealth. Put differently, we think that, in modern society, the benefit of striking a balance between wellbeing and security presents an opportunity. Well-controlled, our Solution that promotes this as a business provides an alternative to classic socialism with far-reaching, positive implications.

### SUMMARY

In one aspect, provided herein is a unique solution—that utilizes a mix of the various embodiments for which we seek patent protection—with the characteristics of both a product and a service. Proper utilization and intelligent administration of such a solution will solve these fundamental issues of modern society in countries individually, but perhaps worldwide as well; while providing a significant profit opportunity for the product/service provider. Such a solution cannot be characterized as a fundamental economic practice, nor can it be considered a building block of any modern economy; nor do we believe such a solution exists or has ever been considered, let alone developed. The same can be said for the individual embodiments. Thus, we are applying for patent protection for: (i) The Income Equality Generator, (ii) The Wealth Equality Generator, (iii) Future Income Swaps. (iv) Future Wealth Swaps, (v) Income Verification for Future Income Swaps, and (v) Wealth Verification for Future Wealth Swaps, all as described herein.

What is possible by practicing embodiments of the present invention is set forth in part in the description which follows, and in part is obvious from the description, or may be learned by practice of the invention. The possibilities of embodiments of the present invention are realizable and attainable by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain principles of the invention

### BRIEF DESCRIPTION OF THE DRAWINGS

FIG. 1 shows an embodiment of an income equality generator having five break points, a United States dollar currency denomination, and premiums included.

FIG. 2 shows an embodiment of an income equality generator having three break points, a United States dollar currency denomination, and premiums included.

FIG. 3 shows an embodiment of an income equality generator having three breakpoints, a Euro currency denomination, and premiums included.

FIG. 4 shows an embodiment of an income equality generator having three breakpoints, three different levels, a Euro currency denomination, and premiums included.

FIG. 5 shows an embodiment of an income equality generator having three breakpoints, different levels, a Euro currency denomination, and no premiums.

FIG. 6 shows an embodiment of a wealth equality generator having five breakpoints, a United States dollar currency denomination, and premiums included.

FIG. 7 shows an embodiment of a wealth equality generator having three breakpoints, a United States dollar currency denomination, and premiums included.

FIG. 8 shows an embodiment of a wealth equality generator having three breakpoints, a Euro currency denomination, and premiums included.

FIG. 9 shows an embodiment of a wealth equality generator having three breakpoints, at different levels, a Euro currency denomination, and premiums included.

FIG. 10 shows an embodiment of a wealth equality generator having three breakpoints, at different levels, a Euro currency denomination, and no premiums.

### EMBODIMENTS

Reference will now be made in detail to the representative embodiments of the invention, examples of which are illustrated in the accompanying figures. Wherever possible, the same reference numbers will be used throughout the figures to refer to the same or like parts.

### INCOME EQUALITY GENERATOR & WEALTH EQUALITY GENERATOR

### Income Equality Generator

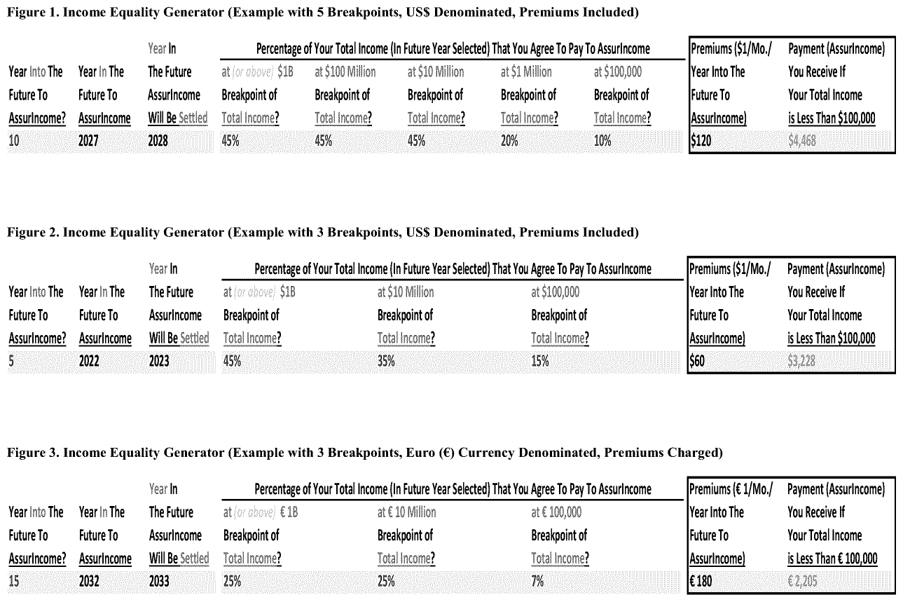

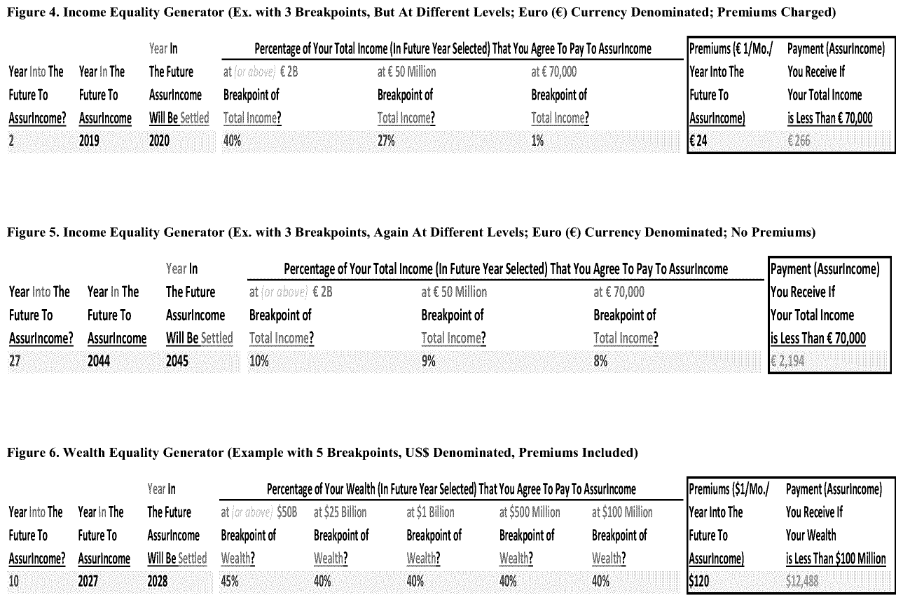

The Income Equality Generator (the “IEG”) is a novel information form (note: it may be presented on paper, in an electronic spreadsheet, on the internet, or in any other medium) and process. In one aspect, it allows the user to input certain preferences pertaining to which year in the future the user would like to create equalizing income for him/herself (in our vernacular, to do so is to “AssurIncome”). Simultaneously, it allows the user to input the percentage of the user's income (note: in all instance in which we refer to income this may be total income, adjusted gross income, or any other measure of income as we so define) in the year in question that the user agrees to pay to AssurIncome (the “payback”) should the user's income exceed certain pre-established thresholds (a/k/a breakpoints). The process then identifies for the user the payment (AssurIncome) the user would receive in return for agreeing to the payback to AssurIncome. We show representative mock-ups of the TEG in FIGS. 1-5. In some embodiments, the information form may be presented on paper, in an electronic spreadsheet, on the internet, or in any other non-transient medium. In all instances in which we refer to income this may be total income, adjusted gross income, or any other measure of income as we so define. The IEG can have any number of different breakpoints; can be denominated in any currency (e.g., U.S. $, Euro/€, Chinese Renminbi, Bitcoin, among all others); can utilize breakpoints at any level of income; and can include, or not include, premiums. FIGS. 1-5 are meant to demonstrate the variability in the structure of the IEG, but are not necessarily meant to be limiting or comprehensive. When the IEG is used broadly by individuals, and payments and distributions are property administered; this results in greater income equality for the individual and improved income equality throughout the economy.

In another aspect of the JEG, the novel information form and process allows the user to enter relevant personal, social, demographic, and other factors. The process then provides the user with the payment amount and AssurIncome the user would receive, at a future income level that is below a pre-established threshold/breakpoint, in return for (i) investing currently (i.e., an upfront payment or a series of payments) and/or (ii) payments of pre-agreed percentages of the user's income in the future year in question should the user's income exceed certain pre-established thresholds/breakpoints.

### Wealth Equality Generator

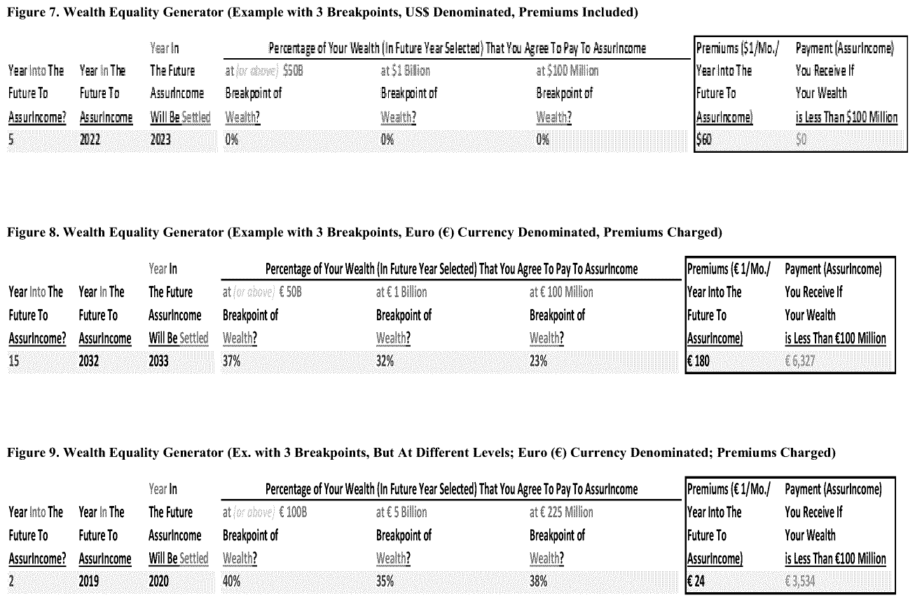

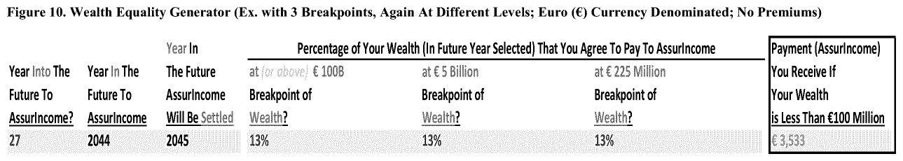

Similar to the IEG, the Wealth Equality Generator (the “WEG”) is a novel information form and process that, in one aspect, allows the user to input certain preferences pertaining to which year in the future the user would like to create wealth equality for him/herself and the percentage of the user's future wealth (as measured in the year in question) that the user agrees to pay to AssurIncome should the user's future wealth exceed certain pre-established thresholds (a/k/a breakpoints). The process then identifies for the user the payment (AssurIncome) the user would receive in return for agreeing to the payback to AssurIncome. We show representative mock-ups of the WEG in FIGS. 6-10. The WEG can have any number of different breakpoints; can be denominated in any currency (e.g., U.S. $, Euro/€, Chinese Renminbi, Bitcoin, among all others); can utilize breakpoints at any level of wealth; and can include, or not include, premiums. FIGS. 6-10 are meant to demonstrate the variability in the structure of the WEG, but are not necessarily meant to be limiting or comprehensive. When the WEG is used broadly by individuals, and payments and distributions are properly administered, this results in greater wealth equality for the individual and improved wealth equality throughout the economy.

In another aspect of the WEG, the novel information form and process allows the user to enter relevant personal, social, demographic, and other factors. The process then provides the user with the payment amount and AssurIncome the user would receive, at a future wealth level that is below a pre-established threshold/breakpoint, in return for (i) investing currently (i.e., an upfront payment or a series of payments) and/or (ii) payments of pre-agreed percentages of the user's wealth in the future year in question should the user's wealth exceed certain pre-established thresholds/break points.

### FUTURE INCOME SWAPS & FUTURE WEALTH SWAPS

### Future Income Swaps

Within designed limits, and utilizing a program that limits risk to the issuer, we describe a product that will provide an income enhancement (from the product) to the purchaser's otherwise unenhanced future income. Technically, the product will be transmitted from issuer to purchaser via a contract. In one aspect, the product will require only that the purchaser pledge to pay a percentage of his/her income in the future year covered by the product, should the purchaser's income exceed certain pre-established thresholds/breakpoints (consistent with the use of the IEG, as detailed above). In another aspect, the purchaser may buy the product using current income or savings (note: an upfront payment or a series of payments), while still pledging to pay a percentage of his/her income in the future year covered by the product, should the purchaser's income exceed certain pre-established thresholds/breakpoints. In either case, we have named this a Future Income Swap (an “FIS”). It is this product (i.e., the FIS), not the contract, for which we seek patent protection. This uniquely designed product will provide, within limits, 1) at an ascertainable upfront (and/or then recurring) cost, and 2) for any individual who chooses to make such a purchase, an enhancement to annual income in the future.

Given the societal issues, extenuating circumstances, and desire for wellbeing and security articulated in the Introduction, and given that most individuals are faced with limited control over annual earnings, we believe most individuals are likely to take advantage of an arranged contractual relationship in which they will:
commit to pay back to the contract issuer a portion of any realized annual income exceeding pre-established thresholds/breakpoints and, in some circumstances, to make an upfront payment or payments, or both, and
trade this payback and/or payment (or combinations thereof) for an expected yearly payment for one or more years in the future.

We believe that the Solution is also applicable in the business world, conceptually providing a way for corporations that may need to stabilize profitability as well as in other countries with varied socioeconomic systems, but particularly those with economies generally mirroring that of the United States.

We have created an algorithm to manage the Solution and the process, and as the basis for the specialized business that will utilize it. The algorithm will be the basis for the way in which each unique FIS is constructed, but it is not the algorithm itself for which we seek patent protection. Rather, it is the product of the algorithm (i.e., the FIS) and its method of use. Following are detailed descriptions of how the algorithm may be used to create a FIS, as well as detailed practical examples.

Example 1: In the first aspect, the issuer will create a FIS for the user and make available a purchasable contract. The algorithm will allow an individual to enter a percentage amount of the person's future income (the “POPFI”)—in the event that his or her income exceeds a predetermined threshold, or thresholds—that the individual agrees to pay back to the contract issuer, with the algorithm calculating implied POPFI's (based on straight-line method, double declining balance method, or any other accounting methodology that we may choose) at all income levels other than the select future income levels. Assuming the individual qualifies, as based on agreeing to the POPFI terms (which are identified in general later in this application) as well as agreeing to the face contract amount of the income enhancement, which will also be the amount paid to the individual in the event that the individual's income does not reach a minimum income floor (the “MIF”) for a future year or years, and further, and assuming the individual pays for the contract, the contract will then provide for the payment to said individual, from revenue accumulated by the issuer, of a stipulated amount in a predetermined future year or years.

In this aspect, the amount paid in the future to the buyer of the contract will help fill a gap between actual aggregated gross income received from all other sources as received by the individual for that particular year, and the MIF.

The pool of capital available to make these payments to eligible contract holders will include the sum of the amounts paid by individuals who purchase contracts and the POPFI, less expenses. Expenses will include a spread for the issuer, as well as operational expenses.

A practical example is that a person will use the IEG to create a FIS for five years in the future by entering 5 under “Year Into the Future To Assur Income?” in the IEG that appears in FIG. 1-5. below. This is a single, discrete example, since the person could select any year in the future. Next, the person will enter POPFI's for the respective breakpoints of $1 billion of total income. $100 million of total income, $10 million of total income. $1 million of total income, and $100,000 of total income. These breakpoints are examples only. since any series of breakpoints can be pre-determined. While the algorithm will adjust over time, if the individual enters breakpoint 45%, 45%, 45%, 20%, and 2%, respectively, the income enhancement may be $1,993 (or any agreed amount) if the individual's total income is less than $100,000. Alternatively, if the individual enters breakpoints 20%, 20%, 20%. 20%, and 10%, respectively, the income enhancement may be $3.000 (or any agreed amount) if the individual's total income is less than $100.000. And so on. There are an infinite number of combinations of (i) “Years Into the Future To AssurIncome?” combined with (ii) Pre-determined breakpoints, (iii) POPFI's, and (iv) AssurIncome if the person's actual income in the future year is less than $100.000 (in this example).

Example 2: In the second aspect, the contract issuer will make available a purchasable contract based on a different algorithm. The algorithm will predict the person's earning potential on a year-by-year basis derived from relevant personal, social, demographic, and other factors. Assuming the person qualifies, as based on predetermined and agreed individual expected income (the “IEI”), and further, and assuming the individual purchases the contract, the contract will provide for the payment to said person, from revenue accumulated by the issuer, of a stipulated amount in a predetermined future year or years. This amount will fill the gap between the IEI and a determined (or possibly negotiated) maximum income ceiling (the “MIC”) for that future year or years.

The amount paid in the future to the buyer of the contract (defined as MIC-IEI, if aggregated actual income falls between the IEI and the MIC) will fill a gap between aggregated actual gross income received from all other sources as received by the individual for that particular year, and the face contract amount of the income enhancement.

The pool of capital available to make these payments to eligible contract holders will include the sum of the amounts paid by individuals who purchase contracts and the POPFI, less expenses. Expenses will include a spread for the issuer, as well as operational expenses. Conceptually, the contract may be standardized, or customized as desired by the purchaser.

In executing the contract, the purchaser would simultaneously agree to pay back to the contract issuer a POPFI if his or her income exceeds a predetermined threshold, or thresholds. This would also be applicable in the event the purchaser is a recipient of a windfall, e.g., he or she wins a lottery or, to give other examples, if the person becomes a highly compensated professional athlete or entertainer who exceeds his or her expected performance and income levels.

### Future Wealth Swaps

Within designed limits, and utilizing a program that limits risk to the issuer, we will create a product that will provide a wealth enhancement (from the product) to the purchaser's otherwise unenhanced future wealth. Technically, the product will be transmitted from issuer to purchaser via a contract. In one aspect, the product will require only that the purchaser pledge to pay a percentage of his/her wealth in the future year covered by the product, should the purchaser's wealth exceed certain pre-established thresholds and breakpoints (consistent with the use of the WEG, as detailed above). In another aspect, the purchaser may buy the product using current income or savings (note that an upfront payment or a series of payments is envisioned), while still pledging to pay a percentage of his/her wealth in the future year covered by the product, should the purchaser's wealth exceed certain pre-established thresholds/breakpoints. In either case, we have named this a Future Wealth Swap (an “FWS”). It is this product (i.e., the FWS) and method of use thereof, not the contract, for which we seek patent protection. This uniquely designed product will provide, within limits, 1) at an ascertainable upfront (and/or then recurring) cost, and 2) for any individual who chooses to make such a purchase, an enhancement to annual wealth in the future.

Given the societal issues, extenuating circumstances, and desire for wellbeing and security articulated in the Introduction, and given that most individuals are faced with limited control over annual earnings, we believe most individuals are likely to take advantage of an arranged contractual relationship in which they will:
commit to pay back to the contract issuer a portion of any realized wealth exceeding pre-established thresholds/breakpoints and in some circumstances, to make an upfront payment or payments, or both, and
trade this payback and/or payment or combinations thereof for an expected yearly payment for one or more years in the future.

We believe that the Solution is also applicable in the business world, conceptually providing a way for corporations that may need to stabilize net worth as well as in other countries with varied socioeconomic systems, but particularly those with economies generally mirroring that of the United States.

We have created an algorithm to manage the Solution and the process, and as the basis for the specialized business that will utilize it. The algorithm will be the basis for the way in which the each unique FWS is constructed, but it is not the algorithm itself for which we seek patent protection. Rather, it is the product of the algorithm (i.e., the FWS) or its method of use. Following are detailed descriptions of how the algorithm may be used to create a FWS, as well as detailed practical examples.

Example 3: In the first aspect, the issuer will create a FWS for the user and make available a purchasable contract. The algorithm will allow a person to enter a percentage amount of the person's future wealth as measured on an established date (the “POPFW”)-in the event that his or her wealth exceeds a predetermined threshold, or thresholds-that the person agrees to pay back to the contract issuer, with the algorithm calculating implied POPFW's (based on straight-line method, double declining balance method, or any other accounting methodology that we may choose) at all wealth levels other than the select future wealth levels. Assuming the person qualifies, as based on agreeing to the POPFW terms as well as agreeing to the face contract amount of the income enhancement, which will also be the amount paid to the individual in the event that the individual's wealth does not reach a minimum wealth floor (the “MWF”) for a future year or years, and further, and assuming the individual pays for the contract, the contract will then provide for the payment to said individual, from revenue accumulated by the issuer, of a stipulated amount in a predetermined future year or years.

In this aspect, the amount paid in the future to the buyer of the contract will help fill a gap between actual wealth from all other sources as accumulated by the individual through that particular year, and the MWF.

The pool of capital available to make these payments to eligible contract holders will include the sum of the amounts paid by persons who purchase contracts and the POPFW, less expenses. Expenses will include a spread for the issuer as well as operational expenses.

A practical example is that a person will use the WEG to create a FWS for five years in the future by entering 5 under “Year Into the Future To AssurWealth?” in the WEG (not shown, but similar in style and substance to the IEG) in FIGS. 6-10. Though this is just one example, as the individual could select any year in the future. Next, the person will enter POPFW's for respective breakpoints of $100 billion of wealth. $10 billion of wealth, $1 billion of wealth. $100 million of wealth, and $10 million of wealth. Though these breakpoints are just examples, as they could be any breakpoints that we pre-determine. While the algorithm will adjust over time, if the individual enters breakpoints of 45%, 45%, 45%, 20%, and 2%, respectively, the income enhancement may be $500 (or any agreed amount if the individual's wealth is less than $10 million. Alternatively, if the individual enters breakpoints of 20%, 20%, 20%, 20%, and 10%, respectively, the income enhancement may be $1,000 (or any agreed amount) if the individual's wealth is less than $10 million. And so on. There are an infinite number of combinations of (i) “Years Into the Future To Assur Wealth?” combined with (ii) Pre-determined breakpoints. (iii) POPFW's, and (iv) Assur Wealth if the person's actual wealth (or net worth) as measured by any standardized method in the future year is less than $10 million (in this example).

Example 4: In the second aspect, the contract issuer will make available a purchasable contract, based on a different algorithm. The algorithm itself will predict the person's wealth potential on a year-by-year basis derived from relevant personal, social. demographic, and other factors. Assuming the person qualifies, as based on predetermined and agreed individual expected wealth (the “IEW”), and further, and assuming the person pays for the contract, the contract will then provide for the payment to said person, from revenue accumulated by the issuer, of a stipulated amount in a predetermined future year or years. This amount will fill the gap between the IEW and a determined (or negotiated) maximum wealth ceiling (the “MWC”) for that future year or years.

The amount paid in the future to the buyer of the contract (defined as MWC-IEW, if aggregated actual wealth falls between the IEW and the MWC) will fill a gap between actual wealth from all other sources as accumulated by the person as of that specific year, and the face contract amount of the wealth enhancement.

The pool of capital available to make these payments to eligible contract holders will include the sum of the amounts paid by individuals who purchase contracts and the POPFW. less expenses. Expenses will include a spread for the issuer as well as operational expenses. Conceptually, the contract may be standardized, or customized as desired by the purchaser.

In executing the contract, the purchaser would simultaneously agree to pay back to the contract issuer a POPFW if his or her wealth exceeds a predetermined threshold, or thresholds. This would also be applicable in the event the purchaser is a recipient of a windfall, e.g., he or she wins a lottery or, to give other examples, if the person becomes a highly compensated professional athlete or entertainer who exceeds his or her expected performance and level of wealth.

### Income Verification for Future Income Swaps

To determine the amount of the settlement for each FIS, in some embodiments, the purchaser's income will need to be verified. Specifically for the process of determining the amount required for settling a FIS, in some embodiments, we claim use of any currently relevant or later developed Internal Revenue Service (“IRS”) (or. for any jurisdiction outside the United States, the relevant taxing authority for that jurisdiction) form that authorizes a third-party to inspect and/or receive tax information (at the time of this application, Form 8821), or grants power of attorney and/or declaration of representative (at the time of this application, Form 2848), or authorizes a transcript of tax return (at the time of this application, Form 4506). We do not claim use of these forms for any purpose other than for use in the process of settling a FIS. In addition, again specifically for the process of determining the amount required for settling a FIS, we claim use of any other legal, publicly or privately developed (now or in the future) and utilized, form that may assist in the determination of income for any specific period of time. Again, we do not claim use of these forms for any purpose other than for use in the process of settling a FIS.

Example 5: The purchaser of a FIS will fill out form 8821 (tax information authorization) and return it to the IRS, which will allow one to receive the purchaser's tax information in order to verify income and settle the FIS.

### Wealth Verification for Future Wealth Swaps

To settle each FWS, in some embodiments, the purchaser's wealth is verified. Specifically for the process of settling a FWS, in some embodiments, we claim use of any U.S. Securities and Exchange Commission Form that discloses ownership, whether of real or intangible property (e.g., Form 3, Form 4, Form 5, etc.). We do not claim use of these forms for any purpose other than the process of settling a FWS. In addition, again specifically for the process of determining the amount required for settling a FWS, we claim use of any other legal, publicly or privately developed (now or in the future) and utilized, form that may assist in the determination of wealth at any specific point in time.

### GENERAL DISCLOSURE

Embodiments and all of the functional operations described in this specification may be implemented in digital electronic circuitry, or in computer software, firmware, or hardware, including the structures disclosed in this specification and their structural equivalents, or in combinations of one or more of them. For example, one or more of the exemplary embodiments may be implemented as one or more computer program products, i.e., one or more modules of computer program instructions encoded on a computer-readable medium for execution by, or to control the operation of, data processing apparatus. The computer readable-medium may be a machine-readable storage device, a machine-readable storage substrate, a memory device, a composition of matter affecting a machine-readable propagated signal, or a combination of one or more of them. The computer-readable medium may be a non-transitory computer-readable medium The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script. or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code).

A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory may be supplemented by, or incorporated in, special purpose logic circuitry.

To provide for interaction with a user. embodiments may be implemented on a computer having a display device, e.g., a CRT (cathode ray tube), LCD (liquid crystal display) monitor, a touchscreen display, etc., for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the techniques disclosed, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet

The computing system may include clients and servers. A client and server are generally remote from each other and typically interact through a communication network. The relationship of client and server arises by virtue of computer programs running on the respective computers and having a client-server relationship to each other.

For example, a computer system associated with a business entity (e.g., an underwriting entity, actuarial entities, insurance companies, a financial institution, an investment bank, etc.) may execute store software applications that perform one or more of the exemplary processes that establish, offer for sale, and maintain financial products consistent with the disclosed embodiments, which may include the exemplary Income or Wealth Equality Generator described above. In certain instances, the computer system may locally store data facilitating the establishment, sale, and/or maintenance of these exemplary financial products (e.g., in a locally accessible data repository, etc.) and additionally or alternatively. may obtain all or a portion of the data from one or more remote data repositories (e.g., network-accessible, cloud-based data repositories and/or data lakes) and accessible computing systems maintained by other business or governmental entities.

What is possible by practicing embodiments of the present invention is set forth in part in the preceding description, and in part is obvious from the description, or may be learned by practice of the invention. The possibilities of embodiments of the present invention are realizable and attainable by means of the elements and combinations particularly pointed out in the claims as detailed herein

What is claimed is:

1. A method of computed inequalities solution for creating a future income or wealth swap, comprising:
(a) writing terms of a call option referenced to future income or wealth into a contract;
and (b) writing terms of a put option referenced to future income or wealth into the contract.

2. A method of claim 1, comprising:
(a) writing the terms of the call option referenced to future income into the contract; and
(b) writing the terms of the put option referenced to future income into the contract.

3. A method of claim 1, comprising:
(a) writing the terms of the call option referenced to future wealth into the contract; and
(b) writing the terms of the put option referenced to future wealth into the contract.

4. A computer implemented method of computed inequalities solution for assuring income of each user from a pool of multiple users, comprising:
(a) inputting, to the computer on behalf of a first user, data representing an assured income year to create equalizing income for the first user, wherein the assured income year is in the future;
(b) inputting, to the computer on behalf of the first user for the assured income year, data representing a payback percentage when income of the first user exceeds one or more preestablished thresholds;
(c) identifying, by the computer for the assured income year, a payment the first user would receive when the first user's income is less than a threshold and in return for agreeing to the payback;
(d) outputting, by the computer, data representing the payment;
(e) outputting, by the computer, terms for a purchasable contract for assuring income of the first user, wherein the terms include a premium for entering the purchasable contract; and thereafter
(f) repeating steps (a)-(e) for each remaining user from the pool of multiple users;
wherein when the premium of each user from the pool of multiple users are paid at the time of entering the pool, the premiums form part of the monies;
wherein, for the assured income year, when income of each user from the pool of multiple users exceeds one or more preestablished thresholds, an amount of money representing each user's payback percentage in step (b), when paid, forms part of the monies; and
wherein, when income of a particular user from the pool of multiple users is less than the threshold in step (c) for the particular user, the particular user would receive, from monies, the payment identified in step (c) for the particular user.

5. The method according to claim 4, wherein, in step (e), the terms further comprise a pledge which includes making one or more premium payments by the first user, and
wherein when a premium payment of each user from the pool of multiple users is paid, the premium payment forms part of the monies.

6. The method of claim 4, wherein the payment identified in step (c) is based on multiplying income by a percentage and by a payback percentage.

7. The method of claim 4, further comprising (g) verifying the first user's income in the assured income year, and wherein step (g) is repeated for each remaining user from the pool of multiple users.

8. A computer implemented method of computed inequalities solution for assuring wealth of each user from a pool of multiple users, comprising:
(a) inputting, to the computer on behalf of a first user, data representing an assured wealth year to create equalizing wealth for the first user, wherein the assured wealth year is in the future;
(b) inputting, to the computer on behalf of the first user for the assured wealth year, data representing a payback percentage when wealth of the first user exceeds one or more preestablished thresholds;
(c) identifying, by the computer for the assured wealth year, a payment the first user would receive when the first user's wealth is less than a threshold and in return for agreeing to the payback;
(d) outputting, by the computer, data representing the payment;
(c) outputting, by the computer, terms for a purchasable contract for assuring wealth of the first user, wherein the terms include a premium for entering the purchasable contract; and thereafter
(f) repeating steps (a)-(e) for each remaining user from the pool of multiple users;
wherein when the premium of each user from the pool of multiple users are paid at the time of entering the pool, the premiums form part of the monies;
wherein, for the assured wealth year, when wealth of each user from the pool of multiple users exceeds one or more preestablished thresholds, an amount of money representing each user's payback percentage in step (b), when paid, forms part of the monies; and
wherein, when wealth of a particular user from the pool of multiple users is less than the threshold in step (c) for the particular user, the particular user would receive, from monies, the payment identified in step (c) for the particular user.

9. The method according to claim 8, wherein, in step (e), the terms further comprise a pledge which includes making one or more premium payments by the first user, and wherein when a premium payment of each user from the pool of multiple users is paid, the premium payment forms part of the monies.

10. The method of claim 8, wherein the payment identified in step (c) is based on multiplying wealth by a percentage and by a payback percentage.

11. The method of claim 8, further comprising (g) verifying the first user's wealth in the assured wealth year, and wherein step (g) is repeated for each remaining user from the pool of multiple users.

12. A method of claim 9, wherein the payment identified in step (c) is based on multiplying wealth by a percentage and by a payback percentage.

13. A method of claim 12 further comprising (g) verifying the first user's wealth in the assured wealth year, and wherein step (g) is repeated for each remaining user from the pool of multiple users.

14. A method of claim 8 further comprising (g) verifying the first user's wealth in the assured wealth year, and wherein step (g) is repeated for each remaining user from the pool of multiple users.

15. A method of claim 5, wherein the payment identified in step (c) is based on multiplying income by a percentage and by a payback percentage.

16. A method of claim 15, further comprising (g) verifying the first user's income in the assured income year, and wherein step (g) is repeated for each remaining user from the pool of multiple users.

17. A method of claim 4, further comprising (g) verifying the first user's income in the assured income year, and wherein step (g) is repeated for each remaining user from the pool of multiple users.
